(19) United States
(12) Patent Application Publication
(10) Pub. No.: US 2024/0403607 A1
(43) Pub. Date: Dec. 5, 2024

(54) METHOD FOR SUPPORTING THE OPERATION OF A VEHICLE WITH A SENSOR UNIT, COMPUTER PROGRAM PRODUCT AND SYSTEM

(71) Applicant: Volkswagen Aktiengesellschaft, Wolfsburg (DE)

(72) Inventors: Serin Varghese, Braunschweig (DE); Jan David Schneider, Wolfsburg (DE)

(21) Appl. No.: 18/578,179

(22) PCT Filed: Jul. 4, 2022
(86) PCT No.: PCT/EP2022/068386

§ 371 Date: Jan. 10, 2024

(30) Foreign Application Priority Data
Jul. 14, 2021 (DE) 10 2021 207 493.6

(51) Int. Cl. G06N 3/045

(52) U.S. Cl. CPC G06N 3/045

(57) ABSTRACT

The invention relates to a method (100) for supporting the operation of a vehicle (2) with a sensor unit (4) for acquiring sensor data (200) for an evaluation in a trained, artificial neural network (10) with a plurality of network elements (11) for intermediate evaluations (210) of the sensor data (200), the method comprising the following steps: providing (102) the sensor data (200) for the neural network (10), evaluating (103) the sensor data (200) by means of the neural network (10) in view of a result. The invention also relates to a computer program product and to a system (1).

### DESCRIPTION

The invention relates to a method for supporting the operation of a vehicle with a sensor unit for acquiring sensor data for analysis in a trained, artificial neural network, a computer program product and a system.

The use of artificial neural networks for analyzing data is known in the prior art per se. From US 2016/0328643 A1 it is known, for example, to analyze image data through a neural network, wherein a behavior of the network is analyzed to enable simplifications of the neural network.

In particular when using neural networks for analyzing sensor data for a vehicle, however, the quality of the sensor data is often not stable during vehicle operation due to various environmental influences. For example, interferences such as fog, snow and/or heavy rain can lead to reduced data quality. If these interferences are not detected, misinterpretations by the neural network may be the result. It is therefore desirable to be able to detect sensor data interferences, especially if the sensor data is to be interpreted for autonomous driving or for driver assistance systems.

It is the object of the present invention to at least partially eliminate the above disadvantages known from the prior art. It is, in particular, an object of the present invention to improve safety during vehicle operation with regard to sensor interferences, preferably with little computing effort.

The above object is accomplished by a method having the features of claim 1, a computer program product having the features of claim 14, and a system having the features of claim 15. Further features and details of the invention derive from the respective dependent claims, the description and the figures. Features and details described in connection with the method according to the invention naturally also apply in connection with the computer program product according to the invention and/or the system according to the invention and vice versa so that reference is or can always be made reciprocally with respect to the disclosure of the individual aspects of the invention.

According to a first aspect of the invention, a method for supporting the operation of a vehicle is provided. The vehicle has a sensor unit for acquiring sensor data, which sensor unit is provided for analysis in a trained, artificial neural network. The artificial neural network has a plurality of network elements for interim analyses of the sensor data, in particular, within the neural network. The method further comprises the following steps:
Providing the sensor data for the neural network, in particular, by the sensor unit,
Analyzing the sensor data for detecting at least one event by the neural network, in particular, in the vehicle,
Monitoring an analysis behavior of the intermediate analyses when analyzing the sensor data, in particular by a computing unit,
Evaluating the sensor data for detecting a sensor interference as a function of the analysis behavior, in particular by the computing unit,
Carrying out a reaction measure depending on the analysis of the sensor data, in particular, by the computing unit and/or a driver assistance system of the vehicle.

Advantageously, the vehicle can be operated in an at least partially automated operating mode using a driver assistance system and/or in an autonomous operating mode. The sensor unit may comprise one or more vehicle sensors. The sensor unit comprises, in particular, a forward-looking sensor system for detecting a vehicle environment of the vehicle. The sensor data may be, for example, image data, radar data and/or Lidar data.

The neural network may also be referred to as a neural net. The neural network is a so-called deep neural network. Preferably, the neural network is a machine learning-based network with several, preferably three or more, layers and/or parameters for processing input data and for outputting output data. The neural network may preferably be implemented in the computing unit in trained form. The neural network may be part of a detection module of the computing unit. For example, the neural network can be trained during a development process using reference data from the sensor data to be able to detect the event. Preferably, the event can be an event in a vehicle environment during operation of the vehicle. For example, the event may comprise an appearing of another road user, such as a pedestrian or another vehicle. However, it is also conceivable that, when detecting the event, a traffic sign that the vehicle approaches is detected. It may, in particular, be provided that for detecting the event an object detection is executed when analyzing the sensor data. For this purpose, boxes may be rendered around objects in the vehicle environment. Preferably, the sensor data can be classified according to events during the analysis. In particular, the sensor data can be analyzed pixel by pixel when analyzing the sensor data. The analysis of the sensor data may be carried out completely until an overall analysis is established. However, it is also conceivable that the analysis of the sensor data is interrupted if a sensor interference is detected when evaluating the sensor data.

The network elements may, for example, be network nodes of the neural network. Preferably, the network elements may comprise kernels, network layers, network filters and/or weightings of the neural network. The interim analyses may comprise, for example, scalars, which are output by the network elements when analyzing the sensor data. When monitoring the analysis behavior, the analysis behavior of the interim analyses of some or all network elements of the neural network can be monitored, in particular analyzed. When evaluating sensor data for detecting the sensor interferences, it is possible, in particular, to check and/or determine a presence of the sensor interference. For example, it can be determined if, based on the analysis behavior, the presence of the sensor interference is sufficiently plausible. In particular, the sensor data can be classified as interference-affected and/or interference-free or as stable and/or unstable sensor data during evaluation. It is therefore conceivable that when evaluating the sensor data, it is determined whether the neural network has a high error rate when evaluating the sensor data due to the data quality of the sensor data.

In particular, the sensor interference may be an external interference of the sensor data. In particular, the sensor interference may be caused by weather conditions in the vehicle environment. For example, the sensor interference may comprise fog, heavy rain and/or the like.

The reaction measure may comprise interfering with the operation of the vehicle.

However, it is also conceivable that the reaction measure includes a notification to the driver of the vehicle to inform the driver that the sensor unit is interfered with. Furthermore, the reaction measure may include a request for further sensor data to validate or falsify the sensor interference.

By monitoring the analysis behavior, the neural network itself can be analyzed to detect the sensor interference based on the behavior of the neural network. This makes it possible to detect and/or predict incorrect behavior of the neural network. As a result, misinterpretation of the sensor data can be avoided, thereby improving safety during operation of the vehicle.

It is further conceivable in a method according to the invention that the method comprises the following step:
Identifying key elements of the plurality of network elements, in particular by the computing unit, a server and/or the vehicle.

Preferably, the interim analyses of the key elements are monitored when monitoring the analysis behavior. The key elements can be understood, in particular, as sensitive network elements whose interim analyses behave characteristically in the event of a sensor interference. In particular, only the interim analyses of the key elements are monitored when monitoring the analysis behavior. As a result, a required computing capacity can be reduced. It is conceivable that the identification of the key elements takes place in a separate process. However, it is also conceivable that a collection, in particular, in the form of a list and/or a catalog, of the key elements is received from the vehicle to identify the key elements. For example, the collection of key elements can be provided by a server. Thus, a behavior of the interim analyses of the key elements can represent a characteristic for detecting the sensor interference. Furthermore, identifying the key elements can reduce the computing power required for monitoring the analysis behavior and/or analyzing the sensor data.

In a method according to the invention, it is further conceivable that a calibration process is executed to identify the key elements and/or to evaluate the sensor data, in which calibration process interference-affected reference data and interference-free reference data are evaluated by the neural network, preferably with behavioral deviations of the interim analyses being recorded during the calibration process when analyzing the interference-affected reference data and interference-free reference data. The calibration process can be carried out iteratively. The interference-affected reference data can be understood to be exemplary sensor data that has a sensor interference that makes the analysis of the sensor data flawed or error-prone. The interference-free reference data can be understood as exemplary sensor data which, when the sensor data is analyzed, lead to an error-free overall result or an overall result within a tolerance range. For example, a further artificial neural network can be trained during the calibration process in that the further neural network receives the interim analyses and the reference data as input data to output output data in the form of an evaluation for detecting the sensor interference and/or the key elements. The calibration process can thus improve the accuracy with which the sensor interference is detected.

Furthermore, in a method according to the invention, it is conceivable that the calibration process is executed by a server, wherein the evaluation of the sensor data, the monitoring of the analysis behavior and the evaluation of the sensor data are carried out by the vehicle. For this purpose, the identified key elements, the neural network and/or an architecture of the neural network can be transmitted from the server to the vehicle. This means that the results of the calibration process can be made available to several vehicles. Furthermore, the computing load in the vehicle can be reduced. Because the analyzing of the sensor data, the monitoring of the analysis behavior and the evaluating of the sensor data is carried out by the vehicle, a real-time evaluation of the sensor data can be carried out in the vehicle at the same time to be able to react quickly in a driving situation, particularly a critical one.

In a method according to the invention, it is further conceivable that a weighting of the key elements performed when identifying the key elements, wherein the weighting is taken into account when evaluating the sensor data. When evaluating the sensor data for detecting the sensor interference, the weighting may comprise, for example, weighting factors. The weightings may be determined during the calibration process. For example, during the calibration process, it may be recognized that the behavior of the interim analyses of certain key elements has a stronger influence on the evaluation of the sensor data with regard to the sensor interference than the behavior of the interim analyses of other key elements. This can be taken into account by the weighting, as a result of which the sensor interference can be detected with greater accuracy.

Furthermore, in a method according to the invention, it may advantageously be provided that, when evaluating the sensor data and/or monitoring an analysis behavior of the interim analyses, an averaging is performed for several interim analyses. The averaging may be performed for several network elements. However, it is also conceivable that during the averaging process, a mean value is calculated for each network element or key element in successive interim analyses. This can, for example, reduce the influence of measurement errors.

Preferably, a method according to the invention may provide for a comparison of the analysis behavior to a reference behavior of the interim analyses when evaluating the sensor data, wherein at least one limit value for a deviation of the analysis behavior from the reference behavior for detecting the sensor interference, i.e., in particular, for detecting the presence of the sensor interference, is specified for the evaluation of the sensor data. The reference behavior can be determined during the calibration process based on the interference-free reference data. The limit value can be determined during the calibration process using the interference-affected reference data, in particular, by comparing the analysis behavior during an analysis of the interference-affected and interference-free reference data. It may be provided, for example, that the sensor interference is detected when the limit value is reached or exceeded. In particular, several limit values may be provided for the interim analyses. Thus, an advantageous detection of the sensor interference may be realized.

In a method according to the invention, it may preferably be provided that the sensor data are classified with regard to an interference classification when evaluating the sensor data, wherein the reaction measure is carried out as a function of the interference classification. The interference classification may, for example, comprise the type of sensor interference. It is thus conceivable that sensor data with fog receive a different interference classification than sensor data with heavy rain. As a result, the reaction measure can be carried out tailored to the interference classification. It may be provided, for example, that the reaction measure is a controlling of driver assistance systems as a function of the interference classification. In particular, a predetermined driver assistance system may be controlled for a specific interference classification.

In a method according to the invention, it may preferably be provided that a reaction measure comprises a validation process for validating the evaluation and/or analysis of the sensor data. The validation process may prevent or postpone an intervention into the driving behavior of the vehicle. In particular, this can provide an additional level of certainty when detecting the sensor interference.

It is, for example, conceivable that the validation process comprises loading the sensor data into a further, artificial neural network which is trained for analyzing sensor data of the interference classification for detecting the event. The further neural network may be trained, for example, for analyzing sensor data with an inference due to fog. As a result, sensor data having a sensor interference can also be analyzed with regard to a sensor interference as a function of the sensor interference. The further neural network may be implemented in the vehicle or in the server.

In the context of the invention, it is further conceivable that the validation process comprises loading the sensor data into a several further, trained, artificial neural networks, wherein a consolidation process is executed to obtain an overall evaluation of the sensor data with regard to the event and/or with regard to the sensor interference. During the consolidation process, the analysis behavior of interim analyses of the other neural networks can be monitored and the sensor data for detecting the sensor interference can be evaluated as a function of the analysis behavior of all further neural networks. For example, the evaluation can take into account whether a majority of the further neural networks classify the sensor data as interference-affected or interference-free. This allows validation through consolidation. For example, the further neural networks may be trained using different training data. As a result, the analysis behavior of the interim analyses of the further neural networks may differ. As a result, errors in detecting the sensor interference can be recognized and/or accuracy in detecting the sensor interference can be improved.

Furthermore, in a method according to the invention, it may advantageously be provided that the reaction measure comprises an automatic triggering of a driving maneuver of the vehicle. For this purpose, for example, a driver assistance system of the vehicle may be controlled. For example, when the sensor interference is detected, a speed of the vehicle can be reduced and/or a driving maneuver can be executed, in particular, to perform an emergency stop of the vehicle. Thus, safe operation of the vehicle can be achieved by intervening in a normal operation of the vehicle when the sensor interference is detected to avoid incorrect behavior of the vehicle due to an incorrect analysis by the neural network caused by the sensor interference.

According to a further aspect of the invention, a computer program product is provided. The computer program product comprises commands which, when executed by a computing unit, cause the computing unit to execute a method according to the invention.

Thus, a computer program product according to the invention has the same advantages as those described in detail with reference to a method according to the invention. The method may, in particular, be a computer-implemented method. The computer program product may be implemented as a computer-readable instruction code in any suitable programming language such as, for example, JAVA, C++, C# and/or Python. The computer program product may be stored on a computer-readable memory device such as a data disk, a removable disk drive, a volatile or non-volatile memory, or a built-in memory/processor. The instruction code is able to influence or control a computer or other programmable devices such that the desired functions are executed. The computer program product may further be provideable or provided in a network such as, for example, the Internet from which it can be downloaded by a user when needed. The computer program product may thus be realized both as a software and by means of one or several specific electronic circuits, i.e., in hardware or in any hybrid form, i.e., by means of software components and hardware components.

According to a further aspect of the invention, a system is provided. The system has a vehicle comprising a sensor unit for acquiring sensor data. The system further comprises a computing unit for executing a method according to the invention.

Thus, a system according to the invention has the same advantages as those described in detail with reference to a method according to the invention and/or a computer program product according to the invention. Advantageously, the computing unit may have a processor and/or microprocessor. Furthermore, the computing unit may be integrated in the vehicle and/or a server. In particular, the computing unit may have several computing modules which are distributed decentrally. For example, one computing module of the computing unit may be integrated in the vehicle and another computing module may be integrated in the server. Preferably, the vehicle has a driver assistance system for automatically carrying out driving maneuvers.

Further advantages, features and details of the invention are shown in the following description, in which embodiments of the invention are described in detail with reference to the drawings. The features mentioned in the claims and in the description can each be essential to the invention individually or in any combination. The figures show schematically:

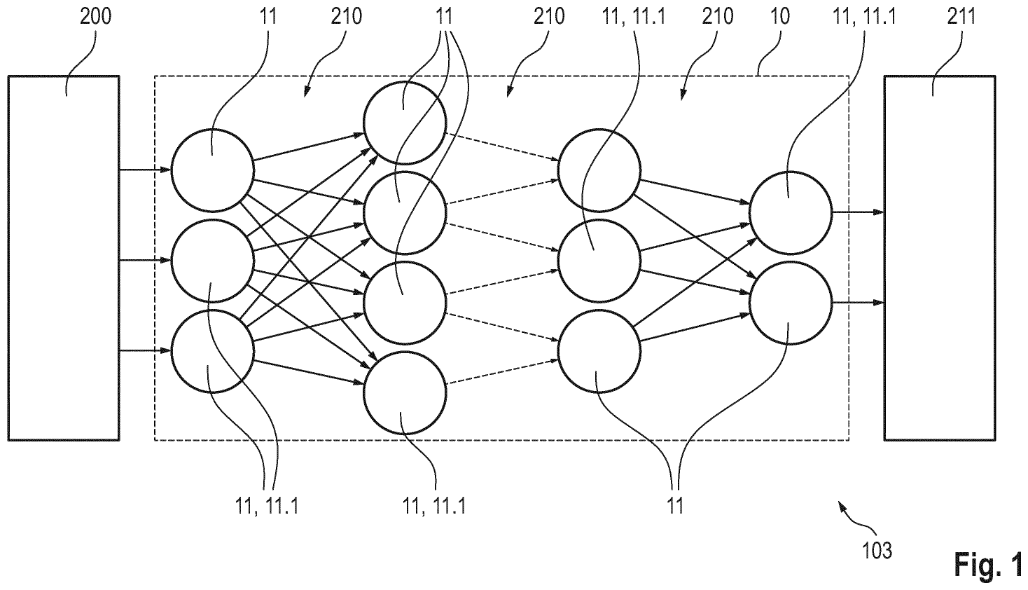

FIG. 1 an artificial, neural network,

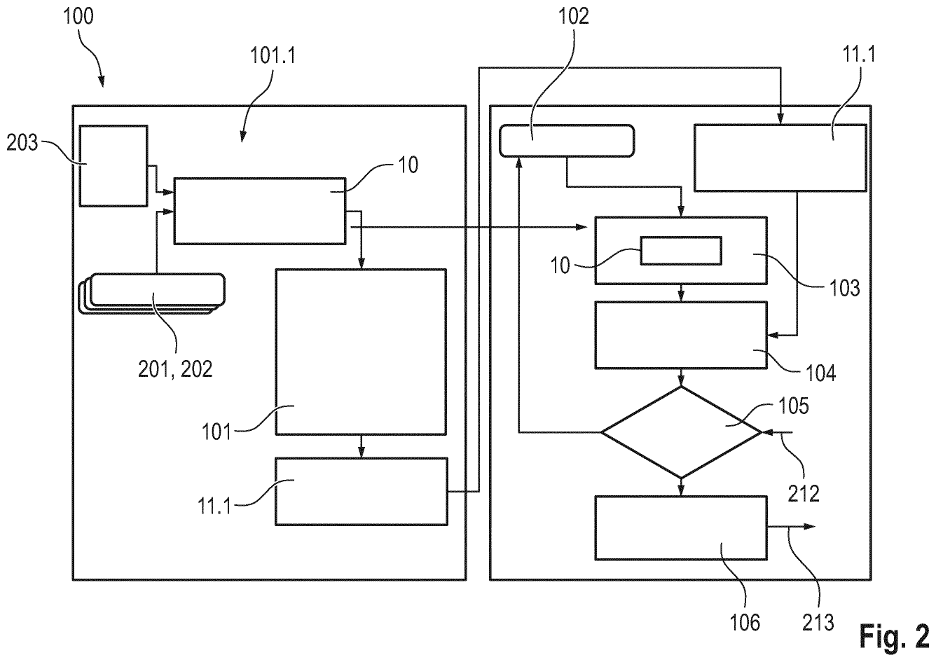

FIG. 2 a method according to the invention for supporting the operation of a vehicle,

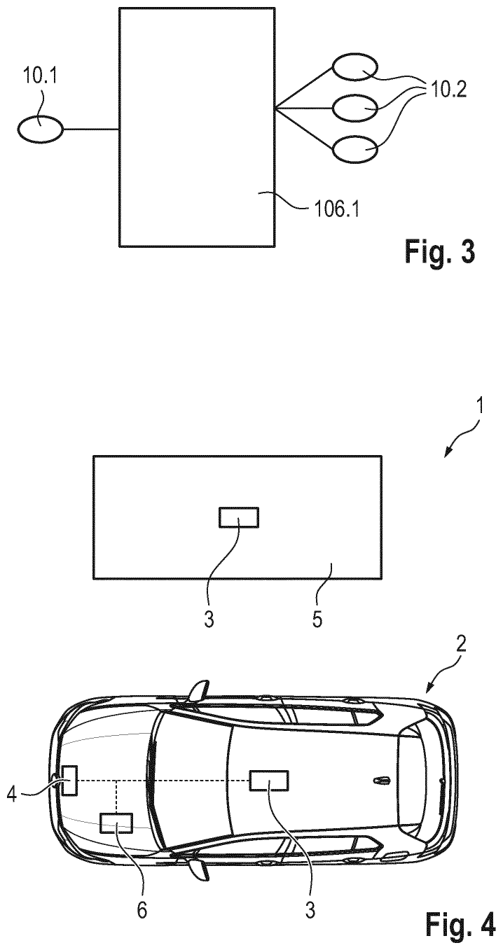

FIG. 3 a validation process of the method,

FIG. 4 a system comprising the vehicle,

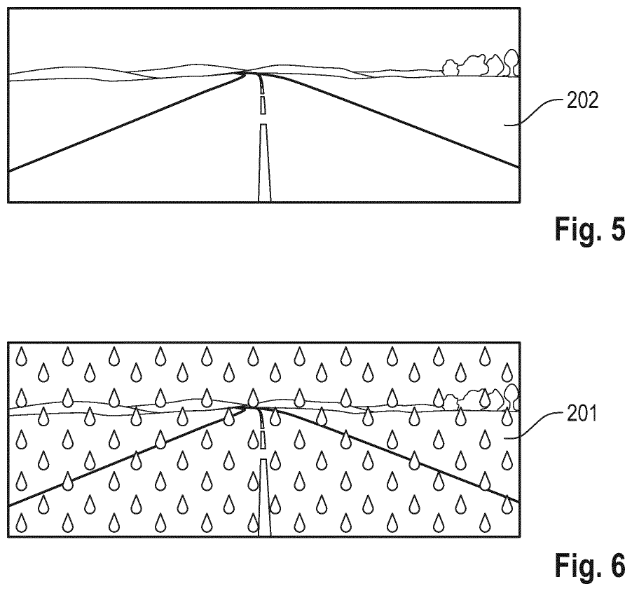

FIGS. 5, 6 reference data for a calibration process of the method.

In the following description of some embodiments of the invention, identical reference signs are used for the same technical features even in different embodiments.

FIG. 1 shows a trained, artificial neural network 10 for analyzing 103 sensor data 200 of a sensor unit 4 of a vehicle 2. A system 1 according to the invention comprising the vehicle 2 and the sensor unit 4 is shown in FIG. 4. The neural network 10 may be implemented in a computing unit 3. The computing unit 3 is preferably integrated in the vehicle 2 and/or a server 5. As shown in FIG. 1, the neural network 10 has a plurality of network elements 11 for interim analyses 210 for analyzing the sensor data 200. The network elements 11 may comprise, for example, network layers, network filters and/or weightings of the neural network 10.

FIG. 2 shows a method 100 according to the invention for supporting an operation of the vehicle 2 with the sensor unit 4 in a diagrammatic representation of method steps. The method 100 is preferably executed by the computing unit 3.

Advantageously, a computer program product is provided for this purpose which comprises commands, which, when executed by the computing unit 3, cause the computing unit 3 to execute the method 100.

To create an overall analysis 211 for an interpretation and/or classification of the sensor data 200 with respect to an event, the method 100 comprises providing 102 the sensor data 200 to the neural network 10 and analyzing 103 the sensor data 200 for a detection of the event by the neural network 10. For example, the event may be the appearing of an object such as another road user in a vehicle environment.

First, however, identifying 101 key elements 11.1 of the plurality of network elements 11 is provided. A calibration process 101.1 is executed for identifying 101 the key elements 11.1, in which calibration process interference-affected reference data 201 and interference-free reference data 202 are analyzed by the neural network 10. For example, if the sensor unit 4 has a camera, the reference data 201, 202 may comprise image data. An example for interference-free reference data 202 is shown in FIG. 5, while an example for interference-affected reference data 201 comprising a sensor interference in the form of rain is shown in FIG. 6. The interference-free reference data 202 may, for example, correspond to the training data of the neural network 10. It may be provided that during the calibration process 101.1 further additional reference parameters 203 are loaded into the neural network 10. Thus, the sensor interference may, in particular, be an external interference, such as an environmental influence. In particular, behavioral deviations of the interim analyses 210 are detected during the calibration process 101.1 when analyzing 103 the interference-affected and interference-free reference data 201, 202. As a result, a characteristic behavior of the neural network 10 can be detected in the form of characteristic interim analyses 210 or a characteristic change in the interim analyses 210 to detect the sensor interference. Preferably, when identifying 101 the key elements 11.1, the key elements 11.1 can also be weighted, wherein, for example, key elements 11.1 whose interim analyses 210 behave more characteristically than other key elements 11.1 are given greater weight for detecting the sensor interference. As a result, in particular, the number of key elements 11.1 can be reduced.

Furthermore, to detect the sensor interference, monitoring 104 an analysis behavior of the interim analyses 210 when analyzing 103 the sensor data 200 is carried out in the method 100. In particular, only the interim analyses 210 of the key elements 11.1 that exhibit the characteristic behavior during the sensor interference are monitored.

This is followed by evaluating 105 the sensor data 200 to detect the sensor interference as a function of the analysis behavior, in particular, taking into account the weighting of the key elements 11.1. Additionally or alternatively, when evaluating 105 the sensor data 200 and/or monitoring 104 the analysis behavior, averaging, in particular over time and/or across elements, may be performed for several interim analyses 210. The sensor interference is, in particular, detected through comparing the analysis behavior to a reference behavior of the interim analyses 210 when evaluating 105 the sensor data 200. The reference behavior can be deduced from the, in particular, interference-free reference data 201, 202. Furthermore, it may be provided that a limit value 212 for a deviation of the analysis behavior from the reference behavior is provided for the evaluation of the sensor data 200. The sensor interference is detected, in particular, when the limit value 212 is reached or exceeded. Furthermore, it is conceivable that several limit values 212 are provided which form a tolerance corridor in which the sensor data 200 are considered to be interference-free. It may be provided that the sensor data 200 are classified with regard to an interference classification 213.

To enable real-time analysis while at the same time requiring low computing capacity in the vehicle 2, the calibration process 101.1 is preferably executed by the server 5 and analyzing 103 the sensor data 200, monitoring 104 the analysis behavior and evaluating 105 the sensor data 200 by the vehicle 2. The server 5 and the vehicle 2 may each comprise a computing module of the computing unit 3.

As a function of evaluating 105 the sensor data 200, a reaction measure 106 is carried out, e.g., automatic triggering of a driving maneuver of the vehicle 2 by a driver assistance system 6. For example, the vehicle 2 can be slowed down when the sensor interference is present to avoid impairment of the vehicle 2 due to misinterpretation of the sensor data 200.

Furthermore, it may be provided that the reaction measure 106 includes a validation process 106.1 for validating the evaluation and/or the analysis of the sensor data 200. As shown in FIG. 3, the validation process 106.1 may comprise loading the sensor data 200 into a further artificial neural network 10.1. The further artificial neural network 10.1 may be specifically trained to recognize the event when evaluating 103 sensor data 200 of the interference classification 213. Additionally or alternatively, the validation process 106.1 may comprise loading the sensor data 200 into several further, trained, neural networks 10.2. A consolidation process is executed by the further, trained, artificial neural networks 10.2 to obtain an overall evaluation of the sensor data 200 with regard to the event and/or with regard to the sensor interference.

By monitoring 104 the analysis behavior, the neural network 10 itself can thus be analyzed to detect the sensor interference. This makes it possible detect and/or predict incorrect behavior of the neural network 10 to avoid misinterpretation of the sensor data 200. As a result, the safety of the vehicle 2 can be improved, in particular, in an at least partially automated or autonomous driving mode, in particular, without the need for high computing capacity in the vehicle 2.

### REFERENCE SIGN LIST

1 System

2 Vehicle

3 Computing unit

4 Sensor unit

5 Server

6 Driver assistance system

10 Trained, artificial neural network

10.1 Trained, artificial neural network

10.2 Trained, artificial neural network

11 Network elements

11.1 Key elements

100 Method

101 Identifying

101.1 Calibration process

102 Providing

103 Analyzing

104 Monitoring

105 Evaluating

106 Reaction measure

106.1 Validation process

200 Sensor data

201 Interference-affected reference data

202 Interference-free reference data

203 Reference parameter

210 Interim analyses

211 Overall analysis

212 Limit value

213 Interference classification

1. A method (100) for supporting the operation of a vehicle (2) with a sensor unit (4) for acquiring sensor data (200) for analysis in a trained, artificial neural network (10) comprising a plurality of network elements (11) for interim analyses (210) of the sensor data (200), comprising the following steps:
Providing (102) the sensor data (200) for the neural network (10),
Analyzing (103) the sensor data (200) for detecting at least one event by the neural network (10),
Monitoring (104) an analysis behavior of the interim analyses (210) when analyzing (103) the sensor data (200),
Evaluating (105) the sensor data (200) for detecting a sensor interference as a function of the analysis behavior,
Carrying out a reaction measure (106) as a function of evaluating (105) the sensor data (200).

2. The method (100) according to any of the preceding claims, characterized in that the network elements (11) comprise network layers, network filters and/or weightings of the neural network (10).

3. The method (100) according to any of the preceding claims, characterized in that the method (100) comprises the following step:
identifying (101) key elements (11.1) of the plurality of network elements (11), wherein, when monitoring (104) the analysis behavior, the interim analyses (210) of the key elements (11.1) are monitored.

4. The method (100) according to any of the preceding claims, characterized in that, for identifying (101) the key elements (11.1) and/or for evaluating (105) the sensor data (200), a calibration process (101.1) is executed, in which interference-affected reference data (201) and interference-free reference data (202) are analyzed by the neural network (10), wherein behavioral deviations of the interim analyses (210) are detected during the calibration process (101.1) when analyzing (103) the interference-affected and interference-free reference data (201, 202).

5. The method (100) according to any of the preceding claims, characterized in that the calibration process (101.1) is executed by a server (5), wherein analyzing (103) the sensor data (200), monitoring (104) the analysis behavior and evaluating (105) the sensor data (200) is carried out by the vehicle (2).

6. The method (100) according to any of the preceding claims, characterized in that the key elements (11.1) are weighted when identifying (101) the key elements (11.1), wherein the weighting is taken into account when evaluating (105) the sensor data (200).

7. The method (100) according to any of the preceding claims, characterized in that an averaging for several interim analyses (210) is performed when evaluating (105) the sensor data (200) and/or when monitoring (104) an analysis behavior of the interim analyses (210).

8. The method (100) according to any of the preceding claims, characterized in that a comparison of the analysis behavior with a reference behavior of the interim analyses (210) is performed when evaluating (105) the sensor data (200), wherein at least one limit value (212) for a deviation of the analysis behavior from the reference behavior for detecting the sensor interference is specified for the evaluation of the sensor data (200).

9. The method (100) according to any of the preceding claims, characterized in that the sensor data (200) are classified with regard to an interference classification (213) when evaluating (105) the sensor data (200), wherein the reaction measure (106) is carried out as a function of the interference classification (213).

10. The method (100) according to any of the preceding claims, characterized in that the reaction measure (106) comprises a validation process (106.1) for validating the evaluation and/or the analysis of the sensor data (200).

11. The method (100) according to any of the preceding claims, characterized in that the validation process (106.1) comprises loading the sensor data (200) into a further, artificial neural network (10.1) which is trained for analyzing (103) sensor data (200) of the interference classification (213) for detecting the event.

12. The method (100) according to any of the preceding claims, characterized in that the validation process (106.1) comprises loading the sensor data (200) into several further, trained artificial neural networks (10.2), wherein a consolidation process is executed to obtain an overall evaluation of the sensor data (200) with regard to the event and/or with regard to the sensor interference.

13. The method (100) according to any of the preceding claims, characterized in that the reaction measure (106) comprises an automatic triggering of a driving maneuver of the vehicle (2).

14. A computer program product, comprising commands which, when executed by the computing unit (3), cause the computing unit (3) to execute the method (100) according to any of the preceding claims.

15. A system (1), comprising a vehicle (2) comprising a sensor unit (4) for acquiring sensor data (200) and a computing unit (3) for executing a method (100) according to any of the preceding claims.
